(19) United States
(12) Patent Application Publication
(10) Pub. No.: US 2018/0334553 A1
(43) Pub. Date: Nov. 22, 2018

(54) REINFORCED RUBBER COMPOSITION COMPRISING A FUNCTIONAL DIENE ELASTOMER

(71) Applicant: COMPAGNIE GENERALE DES ETABLISSEMENTS MICHELIN, Clermont-Ferrand (FR)

(72) Inventors: Etienne FLEURY, Clermont-Ferrand Cedex 9 (FR); Anne-Frédérique SALIT, Clermont-Ferrand Cedex 9 (FR); Justin BELZ, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/778,354

(22) PCT Filed: Nov. 24, 2016
(86) PCT No.: PCT/FR2016/053068

§ 371 Date: May 23, 2018

(30) Foreign Application Priority Data
Nov. 27, 2015 (FR) 1561450

(51) Int. Cl. C08L 9/00; C08C 19/22; B60C 1/00

(52) U.S. Cl. CPC C08L 9/00; C08K 2003/2241; B60C 1/0016; C08C 19/22

(57) ABSTRACT

A rubber composition based at least on a reinforcing filler, on a Lewis or Bronsted acid and on a modified diene elastomer is provided. The diene elastomer bears one or more pendant associative groups comprising at least one nitrogen atom. The diene elastomer before modification is obtained by stereospecific polymerization in the presence of a neodymium-based Ziegler-Natta catalytic system. The Lewis acid is selected from the group consisting of aluminium oxides, titanium oxides and the compounds M(L)ₙ, with M being boron, magnesium, aluminium, titanium, iron, zinc, indium or ytterbium, L being a monodentate or bidendate ligand and n being an integer ranging from 2 to 4. The Bronsted acid is selected from the group consisting of sulfonic acids. Such a composition exhibits a very low hysteresis.

This application is a 371 national phase entry of PCT/FR2016/053068 filed on 24 Nov. 2016, which claims benefit of French Patent Application No. 1561450, filed 27 Nov. 2015, the entire contents of which are incorporated herein by reference for all purposes.

### BACKGROUND

### 1. Technical Field

The present invention relates to diene rubber compositions which are reinforced by a filler and which can be used in particular in the manufacture of tires.

### 2. Related Art

In the motor vehicle industry, tires having a low rolling resistance or which do not heat up very much during running are desired. The first performance quality can be desired in order to reduce fuel consumption and the second for increasing the endurance of the tire.

Tires having a low rolling resistance or which do not heat up very much during running can be obtained by virtue of the use of rubber compositions exhibiting low hysteresis.

A rubber composition exhibiting low hysteresis can be obtained in different ways. One of them consists in using, in the rubber composition, coupling agents which make it possible to improve the interaction between the elastomer and the reinforcing filler of the rubber composition. Alternatively, it is possible to use, in the rubber composition, elastomers bearing a functional group which is interactive with respect to the reinforcing filler of the rubber composition.

In particular, it is known, from Patent Applications WO 2012/007442 A1 and WO 2014/090756 A1, to graft, to a diene elastomer, a 1,3-dipolar compound comprising an associative group and thus to synthesize an elastomer bearing pendant associative groups along the chain. The modification of the elastomer has the effect of conferring a lower hysteresis on the diene rubber composition in which it is present.

It is still of advantage, in particular for the purpose of reducing the rolling resistance of tires, to reduce even more the hysteresis of these diene rubber compositions.

### SUMMARY

On continuing their efforts, the Applicant Companies have discovered that it is possible to further reduce the hysteresis of these diene rubber compositions containing a diene elastomer bearing pendant associative groups along the chain. This aim is achieved by introducing, into the reinforced rubber composition, a specific acid together with a functional elastomer resulting from the modification of a certain stereospecific elastomer.

Thus, a subject-matter of the invention is a rubber composition based at least on a reinforcing filler and on a modified diene elastomer which is a diene elastomer bearing one or more associative pendant groups comprising at least one nitrogen atom, characterized in that the diene elastomer, before modification, is obtained by stereospecific polymerization in the presence of a neodymium-based Ziegler-Natta catalytic system and in that the composition comprises an acid which is a Lewis acid selected from the group consisting of aluminium oxides, titanium oxides and the compounds M(L)ₙ or a Bronsted acid selected from the group consisting of sulfonic acids, M being boron, magnesium, aluminium, titanium, iron, zinc, indium or ytterbium, L being a monodentate or bidentate ligand and n being an integer ranging from 2 to 4.

The invention also relates to a tire comprising the rubber composition in accordance with the invention.

### I. DETAILED DESCRIPTION OF EXAMPLE EMBODIMENTS

In the present description, unless expressly indicated otherwise, all the percentages (%) shown are % by weight. The abbreviation “phr” means parts by weight per hundred parts of elastomer (of the total of the elastomers, if several elastomers are present).

Furthermore, any interval of values denoted by the expression “between a and b” represents the range of values greater than “a” and lower than “b” (that is to say, limits a and b excluded), whereas any interval of values denoted by the expression “from a to b” means the range of values extending from “a” up to “b” (that is to say, including the strict limits a and b).

The expression “composition based on” should be understood as meaning, in the present description, a composition comprising the mixture and/or the in situ reaction product of the various constituents used, some of these base constituents (for example the elastomer, the filler or other additive conventionally used in a rubber composition intended for the manufacture of tires) being capable of reacting or intended to react with one another, at least in part, during the various phases of manufacture of the composition intended for the manufacture of tires.

An essential characteristic of embodiments of the invention is the use of a modified diene elastomer which is stereospecific, since it results from the modification of an elastomer obtained by stereospecific polymerization of at least one 1,3-diene in the presence of a neodymium-based Ziegler-Natta catalytic system. In other words, the diene elastomer before modification is obtained by stereospecific polymerization in the presence of a neodymium-based Ziegler-Natta catalytic system. The element neodymium can occur in the diene elastomer before modification and after modification in the metallic form or in the form of neodymium derivatives, preferably in a content of greater than 150 ppm, more preferably in a content of between 150 and 450 ppm. A person skilled in the art understands that the diene elastomer before modification is synthesized in the presence of a catalytic system which uses a neodymium-based metallic precursor. The presence of the element neodymium in the diene elastomer before modification and in the modified diene elastomer results from the neodymium-based catalytic system used in the synthesis of the diene elastomer before modification.

For the record, the stereospecific polymerizations are carried out in the presence of a multicomponent catalytic system of Ziegler-Natta type. The catalytic system involves at least three essential organometallic constituents, which are:
a metallic precursor based on a metal belonging to one of Groups III to VIII;
an agent for alkylating the metal of the metallic precursor, which alkylating agent is based on a metal from Group II or III, such as Mg or Al type;
a halogenating agent, based on an alkylaluminium halide, for example.

The alkylating agent is also known as cocatalyst.

Some catalytic systems make use of only two constituents, that is to say a metallic precursor based on a transition metal and a cocatalyst, of alkylating agent type.

A person skilled in the art knows the conditions for employing these three constituents in order to obtain catalytic systems effective for the stereospecific polymerization of conjugated diene(s), such as described, for example, in the review “Neodymium Based Ziegler-Natta Catalysts and their Application in Diene Polymerization”, Adv. Polym. Sci. (2006), 204, pp 1-154.

Mention may be made, as metallic precursor, of compounds based on iron, cobalt, nickel, chromium, titanium, vanadium or a rare earth metal, such as neodymium.

Mention may be made, as alkylating agent, of organolithium compounds, alkylaluminium compounds or alkylaluminium hydrides or methylaluminoxanes.

Mention may be made, as halogenating agent, of alkylaluminium halides.

According to the properties of the diene elastomer to be synthesized which are desired, such as its macrostructure and its microstructure, and according to the characteristics of the process which are preferred from the viewpoint of the productive output, a person skilled in the art chooses the constituents of the catalytic system and also their relative proportions in order to obtain a catalytic system which makes possible, under the best conditions, the synthesis of the diene elastomer.

In the present patent application, the expression “a neodymium-based catalytic system” is equivalent to saying that the catalytic system contains a neodymium-based metallic precursor.

The polymerization in the presence of a neodymium-based catalytic system is well known and is documented in the Handbook of Polymer Synthesis, Second Edition, H. Kicheldorf, Oskar Nuyken and Graham Swift, 2004, Technology & Engineering.

Among the neodymium-based Ziegler-Natta catalytic systems known for catalysing diene polymerization, neodymium is used, for example, in the form of neodymium carboxylates or phosphates, for the salts most commonly used.

The neodymium-based Ziegler-Natta catalytic system comprises, for example, as cocatalyst, an organoaluminium compound which is preferably chosen from AlR₃ and AlR₂H, where R is chosen from alkyl, cycloalkyl, aryl, alkaryl, aralkyl, cycloalkylalkyl and cycloalkylaryl radicals. Trialkylaluminium compounds or dialkylaluminium compounds are particularly preferred, very particularly when the alkyl radical is a C₂ to C₄ alkyl radical.

The catalytic system, in addition to the neodymium derivative and the cocatalyst, can comprise a halogenating agent. Mention may be made, as halogenating agent, of organoaluminium halides, preferably an XAIR′₂, where R′ is chosen from alkyl, cycloalkyl, aryl, alkaryl, aralkyl, cycloalkylalkyl and cycloalkylaryl radicals and X is a halogen atom, preferably a chlorine atom.

The polymerization can be carried out according to a continuous or batchwise process, in bulk, in solution or in dispersion. In a polymerization in the presence of solvent, the solvent is generally chosen from aromatic or aliphatic hydrocarbon solvents and their mixtures. Mention may be made, as solvent commonly used, of toluene, pentane, hexane, heptane, cyclohexane and methylcyclohexane.

In the continuation of the account, the diene elastomer before modification is also denoted by the diene elastomer of use for the requirements of embodiments of the invention.

The monomer polymerized in order to result in the diene elastomer of use for the requirements of embodiments of the invention is a diene, preferably a 1,3-diene having from 4 to 8 carbon atoms, more preferably butadiene, isoprene or their mixture.

The relative amounts of monomer, of neodymium derivatives, of cocatalyst and, if appropriate, of halogenating agent and of solvent for the manufacture of the diene elastomer of use for the requirements of embodiments of the invention are determined by a person skilled in the art as a function of the characteristics desired for the diene elastomer of use for the requirements of embodiments of the invention, such as the microstructure and the macrostructure, and as a function of desired processing parameters, such as the kinetics or the yield.

The diene elastomer of use for the requirements of embodiments of the invention can be synthesized according to any one of the abovementioned alternative forms of polymerization catalysed by a neodymium-based Ziegler-Natta catalytic system. The diene elastomer of use for the requirements of embodiments of the invention can be a mixture of diene elastomers which differ from one another in their microstructure or their macrostructure.

According to one embodiment of the invention, the diene elastomer of use for the requirements of the invention contains more than 90 mol % of cis-1,4-bonds.

According to a specific embodiment of the invention, the diene elastomer of use for the requirements of the invention is a polybutadiene, a polyisoprene, a copolymer of 1,3-butadiene and of isoprene, or their mixture. The term “their mixture” is understood to mean the mixture of two of these diene elastomers or of these three elastomers.

The modified diene elastomer used in the rubber composition also has another characteristic of bearing pendant associative groups along the chain.

Associative groups is understood to mean groups capable of associating with one another via hydrogen bonds, each associative group comprising at least one donor “site” and one site which is accepting with regard to the hydrogen bond, so that two identical associative groups are self-complementary and can associate together with the formation of at least two hydrogen bonds.

According to a preferred embodiment of the invention, the associative group is selected from the group consisting of the imidazolidinyl, triazolyl, triazinyl, bis-ureyl and ureido-pyrimidyl groups.

According to a preferred embodiment of the invention, the associative group corresponds to one of the following formulae (I) to (V):

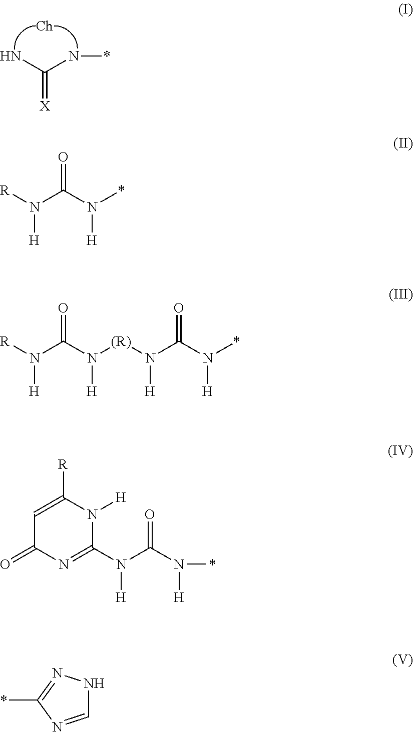

where:
Ch denotes a carbon chain which can optionally contain heteroatoms,
* represents a direct attachment to the chain of the modified diene elastomer,
R denotes a hydrocarbon group which can optionally contain heteroatoms,
X denotes an oxygen or sulfur atom or an NH group, preferably an oxygen atom.

Generally, the ring in the formula (I) is a ring comprising 5 or 6 atoms.

According to a more preferred embodiment of the invention, the group A corresponds to the formula (VI) where * represents a direct attachment to the chain of the modified diene elastomer.

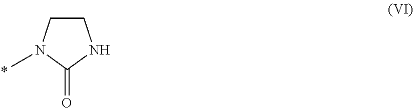

The associative groups represent, in the modified diene elastomer, between 0.01 and 50, more preferably from 0.01 to 10, more preferably still from 0.03 to 5 and better still from 0.03 to 3 mol per 100 mol of monomer units constituting the diene elastomer before modification. The preferred ranges can apply to any one of the embodiments of the invention.

The synthesis of diene polymer bearing one or more pendant associative groups comprising at least one nitrogen atom is well known to a person skilled in the art. For example, a person skilled in the art may refer to the syntheses described in Patent Applications WO 2012007442, WO 2012007443 and WO 2011113818. In the first document, the modified diene polymer is synthesized by grafting, to a starting diene polymer, a 1,3-dipolar compound bearing the associative group; in the second document, the modified diene polymer is synthesized by grafting an azodicarbonyl compound bearing the associative group; in the third document, the modified diene polymer is synthesized by grafting a compound bearing the associative group and bearing a group which is reactive with regard to a diene polymer, it being possible for the reactive group to be, for example, the amine, thiol, epoxy, isocyanate, anhydride, alcohol or carboxylic acid group. The synthesis can be carried out in bulk or in solution, the stoichiometry of the reactants being judiciously chosen by a person skilled in the art according to the number of associative groups to be grafted to the diene polymer.

Mention may be made, by way of compounds as agents for modifying the polymer of use for the requirements of the invention according to any one of the embodiments of the invention, of the compounds of following formulae:

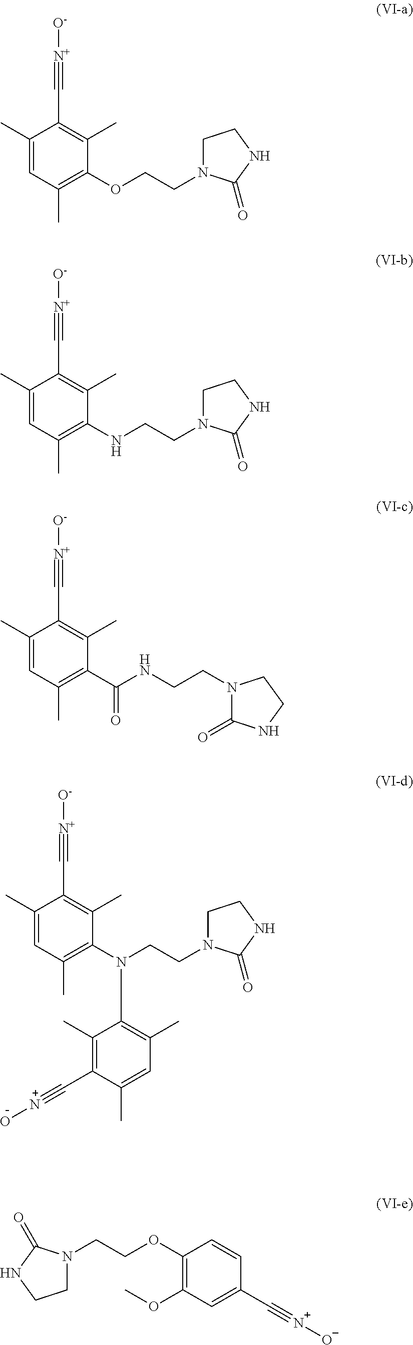 [SMILES: Cc1cc(C)c(OCCN2CCNC2=O)c(C)c1C#[N+][O-] ; Cc1cc(C)c(NCCN2CCNC2=O)c(C)c1C#[N+][O-] ; Cc1cc(C)c(C(=O)NCCN2CCNC2=O)c(C)c1C#[N+][O-] ; Cc1cc(C)c(N(CCN2CCNC2=O)c2c(C)cc(C)c(C#[N+]O)c2C)c(C)c1C#[N+][O-] ; COc1cc(C#[N+][O-])ccc1OCCN1CCNC1=O]

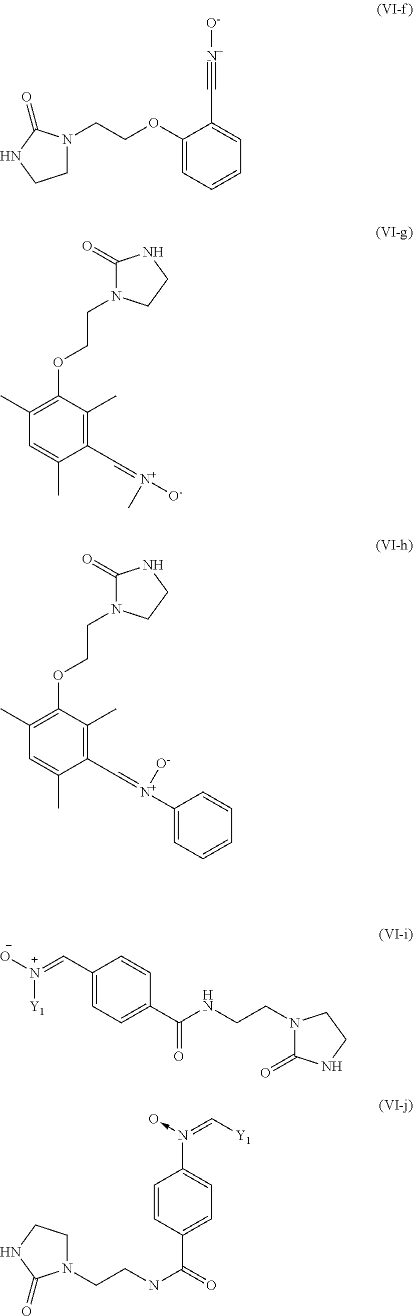

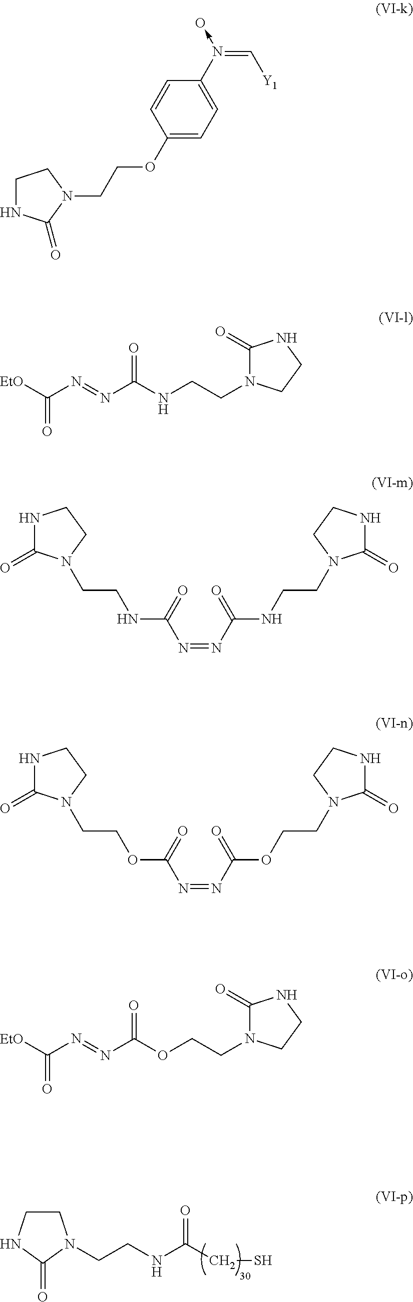

Y₁ being an aliphatic group, preferentially an alkyl group preferably containing from 1 to 12 carbon atoms, or a group containing from 6 to 20 carbon atoms and comprising an aromatic unit, preferably an aryl or alkylaryl group, more preferably a phenyl or tolyl group.

According to a first alternative form of the invention, which is a preferred alternative form of the invention, the Lewis acid of use for the requirements of the invention is selected from the group consisting of aluminium oxides, titanium oxides and the compounds M(L)ₙ, M being boron, magnesium, aluminium, titanium, iron, zinc, indium or ytterbium, L being a monodentate or bidentate ligand and n being an integer ranging from 2 to 4. The value of n depends on the degree of oxidation of M in the compound under consideration.

It should be remembered that a Lewis acid, in accordance with the definition given by the IUPAC in the document PAC, 1994, 66, 1077, Glossary of terms used in physical organic chemistry (IUPAC Recommendations 1994), is an entity which has at least one site which accepts an electron pair. It can concern an isolated compound or the surface of a crystal, in particular metal oxides, such as, for example, TiO₂.

The monodentate ligand can be a halide, an alkoxide group R¹O with R¹ an alkyl preferably having from 1 to 6 carbon atoms, a carboxylate group R¹COO with R¹ an alkyl preferably having from 1 to 7 atoms or a triflate group. It should be remembered that the triflate group has the formula CF₃SO₂O and can be written down as the abbreviation TfO.

According to any one of the embodiments of this alternative form, the bidentate ligand is preferably the enolate of a 1,3-diketone, more preferably acetylacetonate.

According to a preferred embodiment of the first alternative form, the Lewis acid is selected from the group consisting of InCl₃, MgBr₂, SnCl₂, Ti(OR²)₄, TiO₂, Al(OR²)₃, FeCl₃, Yb(OTf) and ZnCl₂, R² denoting a hydrogen atom, a hydrocarbon alkyl group of 1 to 6 carbon atoms, an acyl group R³CO with R³ an alkyl of 1 to 7 carbon atoms or a triflyl group CF₃SO₂.

According to a more preferred embodiment of the first alternative form, the Lewis acid is Ti(OR²)₄, TiO₂ or Al(OR²)₃, R² being as defined above.

According to a second alternative form of the invention, the acid of use for the requirements of the invention is a Bronsted acid selected from the group consisting of sulfonic acids. Mention may be made, as sulfonic acid, of para-toluenesulfonic acid or methanesulfonic acid.

The acid of use for the requirements of embodiments of the invention, whether it is a Lewis acid or a Bronsted acid, is used in the rubber composition at a content preferably of between 0.05 and 5 phr, more preferably between 0.05 and 3 phr and more preferably still between 0.05 and 1 phr. These preferred ranges apply to any one of the embodiments of the invention.

The reinforcing filler is any type of “reinforcing” filler known for its abilities to reinforce a rubber composition which can be used for the manufacture of tires, for example an organic filler, such as carbon black, a reinforcing inorganic filler, such as silica, with which is combined, in a known way, a coupling agent, or also a mixture of these two types of fillers.

Such a reinforcing filler typically consists of nanoparticles, the (weight-)average size of which is less than a micrometre, generally less than 500 nm, most commonly between 20 and 200 nm, in particular and more preferably between 20 and 150 nm.

All carbon blacks, in particular the blacks conventionally used in tires or their treads (“tire-grade” blacks), are suitable as carbon blacks. Among the latter, mention will more particularly be made of the reinforcing carbon blacks of the 100, 200 and 300 series, or the blacks of the 500, 600 or 700 series (ASTM grades), such as, for example, the N115, N134, N234, N326, N330, N339, N347, N375, N550, N683 and N772 blacks. These carbon blacks can be used in the isolated state, as commercially available, or in any other form, for example as support for some of the rubber additives used.

“Reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of pneumatic tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferably silica (SiO₂), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g, in particular between 60 and 300 m²/g. Mention will be made, as highly dispersible precipitated silicas (“HDSs”), for example, of the Ultrasil 7000 and Ultrasil 7005 silicas from Evonik-Degussa, the Zeosil 1165MP, 1135MP, 1115MP and Premium 200MP silicas from Rhodia, the Hi-Sil EZ150G silica from PPG, the Zeopol 8715, 8745 and 8755 silicas from Huber or the silicas with a high specific surface as described in Application WO 03/016387.

In the present account, the BET specific surface is determined in a known way by gas adsorption using the Brunauer-Emmett-Teller method described in The Journal of the American Chemical Society, Vol. 60, page 309, February 1938, more specifically, according to French Standard NF ISO 9277 of December 1996 (multipoint (5 point) volumetric method—gas: nitrogen—degassing: 1 hour at 160° C.—relative pressure p/po range: 0.05 to 0.17). The CTAB specific surface is the external surface determined according to French Standard NF T 45-007 of November 1987 (method B).

The physical state under which the reinforcing inorganic filler is provided is not important, whether in the form of a powder, of microbeads, of granules or else of beads. Of course, reinforcing inorganic filler is also understood to mean mixtures of different reinforcing inorganic fillers, in particular of highly dispersible silicas as described above.

A person skilled in the art will understand that use might be made, as filler equivalent to the reinforcing inorganic filler described in the present section, of a reinforcing filler of another nature, in particular organic nature, such as carbon black, provided that this reinforcing filler is covered with an inorganic layer, such as silica, or else comprises, at its surface, functional sites, in particular hydroxyl sites, requiring the use of a coupling agent in order to establish the bond between the filler and the elastomer. Mention may be made, by way of example, of, for example, carbon blacks for tires, such as described, for example, in patent documents WO 96/37547 and WO 99/28380.

According to any one of the embodiments of the invention, the reinforcing filler comprises a reinforcing inorganic filler, preferably a silica.

According to a specific embodiment of the invention, the inorganic filler, preferably a silica, represents more than 50% by weight of the reinforcing filler of the rubber composition. It is then said that the reinforcing inorganic filler is predominant.

When it is combined with a predominant reinforcing inorganic filler, such as silica, the carbon black is preferably used at a content of less than 20 phr, more preferably of less than 10 phr (for example, between 0.5 and 20 phr, in particular between 2 and 10 phr). Within the intervals indicated, the colouring properties (black pigmenting agent) and UV-stabilizing properties of the carbon blacks are beneficial, without, moreover, adversely affecting the typical performance qualities contributed by the reinforcing inorganic filler.

The content of total reinforcing filler is preferably between 20 and 200 phr. Below 20 phr, the reinforcement of the rubber composition may be insufficient to contribute an appropriate level of cohesion or wear resistance of the rubber component of the tire comprising this composition. Above 200 phr, there is a risk of increasing the hysteresis and thus the rolling resistance of the tires. For this reason, the content of total reinforcing filler is more preferably between 30 and 150 phr, more preferably still from 50 to 150 phr, in particular for use in a tire tread. Any one of these ranges of content of total reinforcing filler can apply to any one of the embodiments of the invention.

In order to couple the reinforcing inorganic filler to the modified diene elastomer, use is made, in a well-known way, of an at least bifunctional coupling agent, in particular a silane, (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional.

Use is made in particular of silane polysulfides, referred to as “symmetrical” or “asymmetrical” depending on their specific structure, such as described, for example, in Applications WO 03/002648 (or US 2005/016651) and WO 03/002649 (or US 2005/016650).

Suitable in particular, without the definition below being limiting, are silane polysulfides corresponding to the following general formula:

Z-G-Sₓ-G-Z
in which:
   x is an integer from 2 to 8 (preferably from 2 to 5);
   the G symbols, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
   the Z symbols, which are identical or different, correspond to one of the three formulae below:

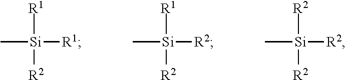

in which:
   the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
   the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

In the case of a mixture of alkoxysilane polysulfides corresponding to the above formula, in particular normal commercially available mixtures, the mean value of the “x” indices is a fractional number preferably of between 2 and 5, more preferably of approximately 4. However, embodiments of the invention can also advantageously be carried out, for example, with alkoxysilane disulfides (x=2).

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Use is made in particular, among these compounds, of bis(3-triethoxysilylpropyl) tetrasulfide, abbreviated to TESPT, of formula [(C₂H₅O)₃Si(CH₂)₃S₂]₂, or bis(3-triethoxysilylpropyl) disulfide, abbreviated to TESPD, of formula [(C₂H₅O)₃Si(CH₂)₃S]₂.

Mention will in particular be made, as coupling agent other than alkoxysilane polysulfide, of bifunctional POSs (polyorganosiloxanes), or else of hydroxysilane polysulfides, such as described in Patent Applications WO 02/30939 (or U.S. Pat. No. 6,774,255) and WO 02/31041 (or US 2004/051210), or else of silanes or POSs bearing azodicarbonyl functional groups, such as described, for example, in Patent Applications WO 2006/125532, WO 2006/125533 and WO 2006/125534.

According to any one of the embodiments of the invention, the coupling agent can be one of the silanes mentioned.

The content of coupling agent is advantageously less than 30 phr, it being understood that it is generally desirable to use as little as possible of it. Typically, the content of coupling agent represents from 0.5% to 15% by weight, with respect to the amount of inorganic filler. Its content is preferably between 0.5 and 16 phr, more preferably within a range extending from 3 to 10 phr. This content is easily adjusted by a person skilled in the art depending on the content of inorganic filler used in the composition.

The rubber composition can also comprise, in addition to the coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state.

According to any one of the embodiments of the invention, the rubber composition can additionally contain a chemical crosslinking agent. The chemical crosslinking makes possible the formation of covalent bonds between the elastomer chains. The chemical crosslinking agent can be a vulcanization system or one or more peroxide compounds.

According to a first alternative form, the vulcanization system proper is based on sulfur (or on a sulfur-donating agent) and on a primary vulcanization accelerator. Additional to this base vulcanization system are various known secondary vulcanization accelerators or vulcanization activators, such as zinc oxide, stearic acid or equivalent compounds, or guanidine derivatives (in particular diphenylguanidine), incorporated during the first non-productive phase and/or during the productive phase, as described subsequently. The sulfur is used at a preferred content of 0.5 to 12 phr, in particular of 1 to 10 phr. The primary vulcanization accelerator is used at a preferred content of between 0.5 and 10 phr, more preferably of between 0.5 and 5 phr. These preferred ranges can apply to any one of the embodiments of the first alternative form of the invention. Use may be made, as (primary or secondary) accelerator, of any compound capable of acting as accelerator of the vulcanization of diene elastomers in the presence of sulfur, in particular accelerators of the thiazole type and their derivatives, and accelerators of thiuram and zinc dithiocarbamate types. Preferably, use is made of a primary accelerator of the sulfenamide type.

According to a second alternative form, when the chemical crosslinking is carried out using one or more peroxide compounds, the said peroxide compound(s) represent from 0.01 to 10 phr. Mention may be made, as peroxide compounds which can be used as chemical crosslinking system, of acyl peroxides, for example benzoyl peroxide or p-chlorobenzoyl peroxide, ketone peroxides, for example methyl ethyl ketone peroxide, peroxyesters, for example t-butyl peroxyacetate, t-butyl peroxybenzoate and t-butyl peroxyphthalate, alkyl peroxides, for example dicumyl peroxide, di(t-butyl) peroxybenzoate and 1,3-bis(t-butylperoxyisopropyl)benzene, or hydroperoxides, for example t-butyl hydroperoxide.

The rubber composition can also comprise all or a portion of the usual additives generally used in the elastomer compositions intended to constitute external mixtures of finished rubber articles, such as tires, in particular treads, such as, for example, plasticizers or extending oils, whether the latter are aromatic or non-aromatic in nature, in particular very weakly aromatic or non-aromatic oils (e.g., paraffin oils, hydrogenated naphthenic oils, MES oils or TDAE oils), vegetable oils, in particular glycerol esters, such as glycerol trioleates, pigments, protective agents, such as antiozone waxes, chemical antiozonants or antioxidants, anti-fatigue agents, reinforcing resins (such as resorcinol or bismaleimide), methylene acceptors (for example phenolic novolak resin) or methylene donors (for example HMT or H3M), such as described, for example, in Application WO 02/10269.

The rubber composition can additionally contain a second diene elastomer other than the modified diene elastomer.

The second diene elastomer is a diene elastomer conventional in the field of tires, such as the elastomers chosen from polybutadienes (BRs), synthetic polyisoprenes (IRs), natural rubber (NR), butadiene copolymers, isoprene copolymers and the mixtures of these elastomers.

It should be noted that the improvement in the properties of the rubber composition will be greater as the proportion of the second diene elastomer in the rubber composition becomes smaller. This is why the modified diene elastomer is present in the rubber composition preferably according to an amount of greater than 50 phr, more preferably of greater than 75 phr and more preferably still of greater than 90 phr. These preferred ranges can apply to any one of the embodiments of the invention.

The rubber composition can be manufactured in appropriate mixers, using two successive phases of preparation according to a general procedure well known to a person skilled in the art: a first phase of thermomechanical working or kneading (sometimes referred to as “non-productive”phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the chemical crosslinking agent, in particular the vulcanization system, is incorporated.

Generally, all the base constituents of the composition included in the tire of embodiments of the invention, with the exception of the chemical crosslinking agent, are intimately mixed by thermomechanical kneading, in one or more stages, until the maximum temperature of between 130° C. and 200° C., preferably of between 145° C. and 185° C., is reached.

By way of example, the first (non-productive) phase is carried out in a single thermomechanical stage during which all the necessary constituents, the optional additional processing aids and various other additives, with the exception of the chemical crosslinking agent, are introduced into an appropriate mixer, such as a normal internal mixer. The total duration of the kneading, in this non-productive phase, is preferably between 1 and 15 min. After cooling the mixture thus obtained during the first non-productive phase, the chemical crosslinking agent is then incorporated at low temperature, generally in an external mixer, such as an open mill; everything is then mixed (productive phase) for a few minutes, for example between 2 and 15 min.

The final composition thus obtained is subsequently calendered, for example in the form of a sheet or of a plaque, in particular for laboratory characterization, or else extruded in the form of a rubber profiled element which can be used as semi-finished tire product for a vehicle.

The rubber composition, which can be either in the raw state (before crosslinking or vulcanization) or in the cured state (after crosslinking or vulcanization), can be a semi-finished product which can be used in a tire, in particular as a tire tread.

The abovementioned characteristics of the present invention, and also others, will be better understood on reading the following description of several exemplary embodiments of the invention, given by way of illustration and without limitation.

### II. Exemplary Embodiments

### II.1-Measurements and Tests Used

II.1.1-Measurement of the Content of Neodymium Derivatives:

Any diene elastomer synthesized in the presence of a catalytic system comprising a metallic precursor may contain the metallic element in the metal form or in the form of derivatives of this metal. In order to quantify the content of the metallic element in the elastomer, whether in the form of metal or of metallic derivatives, use is made of an indirect method which involves the mineralization of a sample of the elastomer and involves inductively coupled plasma atomic emission spectroscopy. This method makes it possible to determine the nature and the content by weight of the metallic element present in the mineralized sample. This measured content is also the content by weight of the metallic element in the sample of non-mineralized elastomer. The content by weight of the metallic element, whether in the form of metal or of metallic derivatives, in the elastomer is thus expressed as parts per million (ppm) of the element neodymium. Thus, 100 ppm of element Nd in the non-mineralized elastomer corresponds to a content of 100 ppm of element Nd measured in the mineralized elastomer sample.

The Method is Described in Detail Below:

Inductively coupled plasma atomic emission spectroscopy (ICP-AES) is a technique which makes it possible to carry out both a qualitative and quantitative elemental analysis.

The determination of the content of catalytic residues by ICP-AES is broken down into two stages: the mineralization of the sample (dissolution of the elements of the sample) and the analysis of the solution obtained by ICP-AES.

The mineralization of the sample consists of an acid digestion assisted by microwaves. A withdrawn sample of several tens of mg is cut into small pieces and placed in a microwave reactor with a mixture of concentrated nitric and hydrochloric acids (the nitric acid must be in excess and the composition of the mixture can vary from 60/40 to 90/10% v:v). The reactor is closed and placed in a microwave oven, where it is subjected to a mineralization programme: the microwaves rotate the polar molecules, resulting in heating by molecular friction and release of heat at the core of the body. Under the effect of the temperature and of the pressure (temperature gradient up to 220° C. and maximum pressure of 75 bar, depending on the temperature), the material becomes oxidized and the elements pass into solution. The solution is subsequently quantitatively decanted into a volumetric flask of known volume and then analysed by ICP-AES.

The ICP-AES technique (gas: argon; power of the plasma: 1100 W; emission wavelengths λ_{Nd}=401.225 nm) uses a plasma to desolvate, vaporize, atomize (sometimes ionize) and excite the elements of the sample solution. When the excited atoms or ions return to their ground state, they emit a wavelength characteristic of the element, the intensity of which is proportional to the concentration of the element in the solution. By comparing the intensities of the emission lines of the element Nd with an external calibration range, the concentration of the element Nd in the sample can be determined

II.1.2-Microstructure of the Elastomers:

The microstructure is determined according to the method described in the paper entitled “Fast and robust method for the determination of microstructure and composition in butadiene, styrene-butadiene, and isoprene rubber by near-infrared spectroscopy”, Vilmin F., Dussap C. and Coste N., Appl. Spectrosc., 2006, 60(6), 619-30.

II.1.3-Mooney Plasticity:

In order to measure the Mooney plasticity, use is made of an oscillating consistometer as described in French Standard NF T 43-005 (1991). The Mooney plasticity measurement is carried out according to the following principle: the composition in the raw state (i.e., before curing) is moulded in a cylindrical chamber heated to 100° C. After preheating for one minute, the rotor rotates within the test specimen at 2 revolutions/minute and the working torque for maintaining this movement is measured after rotating for 4 minutes. The Mooney plasticity (ML 1+4) is expressed in “Mooney unit” (MU, with 1 MU=0.83 newton·metre).

II.1.4-Dynamic Properties:

The dynamic properties are measured on a viscosity analyser (Metravib VA4000) according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, at 60° C., according to Standard ASTM D 1349-99, is recorded. A strain amplitude sweep is carried out from 0.1% to 100% (outward cycle) and then from 100% to 0.1% (return cycle). The results made use of are the loss factor tan(δ) at 60° C. For the outward cycle, the maximum value of tan(δ) observed, denoted tan(δ)max, is indicated. The lower the value of tan(δ)max, the better the gain in hysteresis.

### II.2-Exemplary Embodiments

The rubber compositions C₁ to C₇ are prepared according to the following procedure, it being known that it includes, if appropriate, the modification of the diene elastomer which takes place in the internal mixer according to a procedure analogous to that described in Patent Application WO 2012007442:
the diene elastomer, if appropriate the modifying agent and the Lewis acid are introduced into an 85-cm³ Polylab internal mixer, 70% filled, the initial vessel temperature of which is approximately 50° C.,
thermomechanical working is carried out at 110° C. for 1 to 2 min, the reinforcing filler, the coupling agent and the various other ingredients, with the exception of the vulcanization system, are then introduced,
thermomechanical working is then carried out (non-productive phase) in one stage (total duration of the kneading equal to approximately 5 min), until a maximum “dropping” temperature of 160° C. is reached,
the mixture thus obtained is recovered and cooled and then the vulcanization system (sulfur and accelerator) is added on an external mixer (homofinisher) at 25° C., everything being mixed (productive phase) for approximately 5 to 6 min.

The modifying agent is the 1,3-dipolar compound 2,4,6-trimethyl-3-(2-(2-oxoimidazolidin-1-yl)ethoxy)benzonitrile oxide, the synthesis of which is described in Patent Application WO 2012007442; it is used at a content of 2.13 g per 100 g of elastomer to be modified, i.e. 0.5 mol %, that is to say 0.5 mol per 100 mol of isoprene unit.

The Lewis acid is Al(OiPr)₃ or TiO₂.

The elastomers used, and respectively denoted in Table 1 by the symbols IR-Ti and IR-Nd, are:
a commercial polyisoprene, Nipol 2200 from Nippon Zeon, a polyisoprene prepared by Ziegler-Natta polymerization in the presence of a Ti-based catalytic system,
a polyisoprene prepared by Ziegler-Natta polymerization in the presence of a neodymium-based catalytic system, such as described in Application WO 2014086804. ML(1+4) 100° C.=68, cis-1,4-units=97.2%. It contains more than 150 ppm of the element Nd, in particular between 200 and 450 ppm.

The formulations (in phr) of the compositions C₁ to C₇ are described in Table 1. A Ti elastomer and an Nd elastomer refer below to diene elastomers prepared by Ziegler-Natta polymerization in the presence of a respectively titanium-based and neodymium-based catalytic system.

The composition C1 is not in accordance with embodiments of the invention, since it comprises a Ti elastomer.

The composition C2 is a composition in accordance with embodiments of the invention, since it comprises a modified Nd elastomer and also titanium dioxide.

The compositions C3 to C4, which are devoid of titanium dioxide, are not in accordance with the invention. They are respectively the controls for the compositions C1 and C2.

The composition C5, which contains titanium dioxide but does not contain modified diene elastomer, is not in accordance with the invention.

The composition C6, which contains neither modified diene elastomer nor titanium dioxide, is not in accordance with the invention. It is the control for the composition C5, since it contains the same diene elastomer as C5.

The comparison of the results of the compositions C2, C4 and C5 makes it possible to study the effects relating to the presence of titanium dioxide and of the associative groups or an Nd elastomer.

The composition C7, which differs from the composition C2 in that the Lewis acid is Al(OiPr)₃ instead of titanium dioxide, is in accordance with embodiments of the invention.

### II.3-Properties of the Rubber Compositions in the Cured State

The compositions after vulcanization are calendered, either in the form of plaques (with a thickness ranging from 2 to 3 mm) or thin sheets of rubber, for the measurement of their physical or mechanical properties, or in the form of profiled elements which can be used directly, after cutting and/or assembling to the desired dimensions, for example as semi-finished products for tires, in particular for treads. The results are recorded in Table 2.

In accordance with the state of the art, a decrease in the hysteresis is observed when the diene elastomer bears pendant associative groups: this is because tan(δ)max at 60° C. for C4 is 25% lower than for C6.

It is observed that C1 exhibits a value of tan(δ)max at 60° C. which is equal to that of its control C3, while the composition C1 differs from C3 only by the presence of titanium dioxide. These results show that the addition of titanium dioxide to a composition analogous to C3 is without effect on the hysteresis.

On the other hand, for C2, a decrease in the hysteresis of 20% is observed, in comparison with its control C4. The addition of titanium dioxide to a composition analogous to C4 makes possible a gain in hysteresis in comparison with C4. In comparison with the composition C6, this gain is all the more significant since it is 40%.

Furthermore, it is noted that the value of tan(δ)max at 60° C. of C5 is close to that of C6. The result of C5 shows that there is no gain in hysteresis when titanium dioxide is added to an unmodified diene elastomer, even if it is obtained by stereospecific polymerization in the presence of an Nd-based Ziegler-Natta catalytic system.

It is clearly the combination of the use of titanium dioxide and of the presence of the pendant associative groups on the diene elastomer obtained by stereospecific polymerization in the presence of an Nd-based Ziegler-Natta catalytic system which makes possible a further significant gain in hysteresis.

Results which are comparable with regard to the synergy of the acid and of the presence of the pendant associative groups on an Nd elastomer are observed when the titanium dioxide is replaced with Al(OiPr)₃.

These results, which reflect the synergy of the acid and of the elastomer, are entirely noteworthy and unexpected.

TABLE 1

| | Composition | | | | | | |
|---|---|---|---|---|---|---|---|
| | C1 | C2 | C3 | C4 | C5 | C6 | C7 |
| IR-Ti | 100 | | 100 | | | | |
| IR-Nd | | 100 | | 100 | 100 | 100 | 100 |
| Modifying | 2.13 | 2.13 | 2.13 | 2.13 | 0 | 0 | 2.13 |
| agent | | | | | | | |
| TiO₂ | 0.2 | 0.2 | | | 0.2 | | |
| Al(OiPr)₃ | | | | | | | 0.2 |
| Carbon | 3 | 3 | 3 | 3 | 3 | 3 | 3 |
| black (1) | | | | | | | |
| Silica (2) | 50 | 50 | 50 | 50 | 50 | 50 | 50 |
| Silane (3) | 5 | 5 | 5 | 5 | 5 | 5 | 5 |
| Antiozone | 1 | 1 | 1 | 1 | 1 | 1 | 1 |
| wax | | | | | | | |
| Anti- | 2.5 | 2.5 | 2.5 | 2.5 | 2.5 | 2.5 | 2.5 |
| oxidant | | | | | | | |
| Stearic | 2.5 | 2.5 | 2.5 | 2.5 | 2.5 | 2.5 | 2.5 |
| acid | | | | | | | |
| ZnO | 2.7 | 2.7 | 2.7 | 2.7 | 2.7 | 2.7 | 2.7 |
| Sulfur | 1.5 | 1.5 | 1.5 | 1.5 | 1.5 | 1.5 | 1.5 |
| Accel- | 1.8 | 1.8 | 1.8 | 1.8 | 1.8 | 1.8 | 1.8 |
| erator (4) | | | | | | | |

(1) N234
(2) Silica, Zeosil 1165 MP, Rhodia, in the form of microbeads
(3) TESPT (Si69, Degussa)
(4) N-Cyclohexyl-2-benzothiazolesulfenamide (Santocure CBS, Flexys)

TABLE 2

| Properties in the cured | | | | | | | |
|---|---|---|---|---|---|---|---|
| state | C1 | C2 | C3 | C4 | C5 | C6 | C7 |
| Tanδₘₐₓ | 0.100 | 0.089 | 0.100 | 0.111 | 0.151 | 0.148 | 0.084 |
| 60° C. | | | | | | | |

1. A rubber composition based at least on a reinforcing filler and on a modified diene elastomer, which diene elastomer bears one or more pendant associative groups comprising at least one nitrogen atom, wherein:
the diene elastomer before modification is obtained by stereospecific polymerization in the presence of a neodymium-based Ziegler-Natta catalytic system,
and the composition comprises an acid which is a Lewis acid selected from the group consisting of aluminium oxides, titanium oxides and the compounds M(L)ₙ or a Bronsted acid selected from the group consisting of sulfonic acids,
M being boron, magnesium, aluminium, titanium, iron, zinc, indium or ytterbium,
L being a monodentate or bidentate ligand,
n being an integer ranging from 2 to 4.

2. A rubber composition according to claim 1, in which the content of element neodymium in the diene elastomer before modification is greater than 150 ppm.

3. A rubber composition according to claim 1, in which the diene elastomer before modification contains more than 90 mol % of cis-1,4-bonds.

4. A rubber composition according to claim 1, in which the diene elastomer before modification is a polybutadiene, a polyisoprene, a copolymer of 1,3-butadiene and of isoprene, or their mixture.

5. A rubber composition according to claim 1, in which the associative group is selected from the group consisting of the imidazolidinyl, triazolyl, triazinyl, bis-ureyl and ureido-pyrimidyl groups.

6. A rubber composition according to claim 1, in which the associative group corresponds to one of the following formulae (I) to (VI): 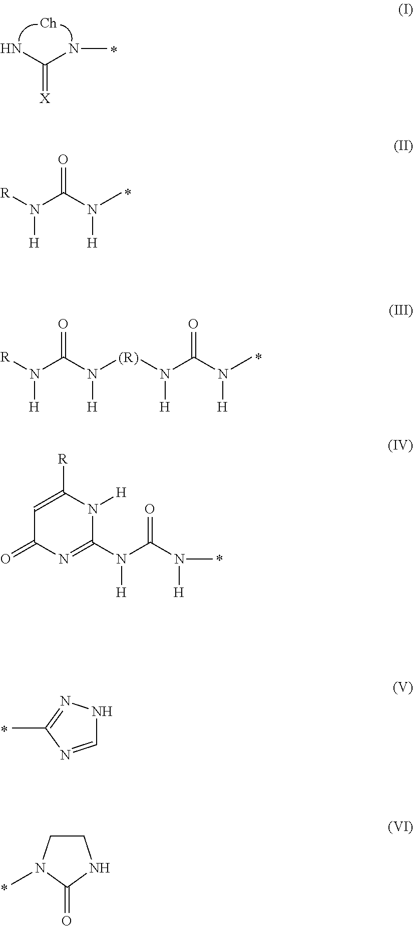
where:
Ch denotes a carbon chain which can optionally contain heteroatoms,
* represents a direct attachment to the polymer chain of the modified diene elastomer,
R denotes a hydrocarbon group which can optionally contain heteroatoms,
X denotes an oxygen or sulfur atom or an NH group.

7. A rubber composition according to claim 1, in which the content of associative group varies within a range extending from 0.01 to 50 mol, per 100 mol of monomer units constituting the diene elastomer before modification.

8. A rubber composition according to claim 1, in which the acid is a Lewis acid.

9. A rubber composition according to claim 1, in which the monodentate ligand is a halide, an alkoxide group R¹O with R¹ an alkyl, a carboxylate group R¹COO with R¹ an alkyl or a triflate group.

10. A rubber composition according to claim 1, in which the bidentate ligand is the enolate of a 1,3-diketone.

11. A rubber composition according to claim 1, in which the Lewis acid is selected from the group consisting of InCl₃, MgBr₂, SnCl₂, Ti(OR²)₄, TiO₂, Al(OR²)₃, FeCl₃, Yb(OTf) and ZnCl₂, R² denoting a hydrogen atom, an alkyl group of 1 to 6 carbon atoms, an acyl group R³CO with R³ an alkyl of 1 to 7 carbon atoms or a triflyl group CF₃SO₂, Tf representing the triflate group.

12. A rubber composition according to claim claim 1, in which the Lewis acid is Ti(OR²)₄, TiO₂ or Al(OR²)₃, R² denoting a hydrogen atom, an alkyl group of 1 to 6 carbon atoms, an acyl group R³CO with R³ an alkyl of 1 to 7 carbon atoms or a triflyl group CF₃SO₂, Tf representing the triflate group.

13. A rubber composition according to claim 1, in which the content of acid is between 0.05 and 5 phr.

14. A rubber composition according to claim 1, in which the reinforcing filler comprises a reinforcing inorganic filler.

15. A tire which comprises a rubber composition defined in claim 1.

16. A rubber composition according to claim 2, in which the content of element neodymium in the diene elastomer before modification is between 150 and 450 ppm.

17. A rubber composition according to claim 6, in which the associative group corresponds to formula (VI).

18. A rubber composition according to claim 6, in which X denotes an oxygen atom.

19. A rubber composition according to claim 7, in which the content of associative group varies within a range extending from 0.01 to 10 mol, per 100 mol of monomer units constituting the diene elastomer before modification.

20. A rubber composition according to claim 9, in which the monodentate ligand is an alkyl having from 1 to 6 carbon atoms or a carboxylate group R¹—COO with R¹ an alkyl having from 1 to 7 atoms.
